(19) United States
(12) Patent Application Publication
(10) Pub. No.: US 2015/0314321 A1
(43) Pub. Date: Nov. 5, 2015

(54) PROTECTION DEVICE AND A METHOD IMPLEMENTING SUCH A DEVICE

(71) Applicant: MESSIER-BUGATTI-DOWTY, Velizy Villacoublay (FR)

(72) Inventor: Marine KRATZ, VELIZY VILLACOUBLAY (FR)

(73) Assignee: MESSIER-BUGATTI-DOWTY, VELIZY VILLACOUBLAY (FR)

(21) Appl. No.: 14/699,339

(22) Filed: Apr. 29, 2015

(30) Foreign Application Priority Data
Apr. 30, 2014 (FR) 14 53985

(51) Int. Cl. B05C 21/00; C25D 5/02; B05D 1/32

(52) U.S. Cl. CPC B05C 21/005; B05D 1/32; C25D 5/022

(57) ABSTRACT

A protection device (1) for protecting a portion to be protected of a part, the device comprising a separable body (2) that can be separated into at least two sub-elements (4, 5), each sub-element (4, 5) having a cavity (6, 7) for receiving at least partially the portion to be protected of the part, the device having holding means (4.11, 4.12, 4.21, 4.22, 5.11, 5.12, 5.21, 5.22) for holding the sub-elements (4, 5) in position relative to one another, and at least one of the sub-elements (4, 5) having a fraction of its cavity (6, 7) that is provided with a surface (30, 31) that opposes relative sliding between the protection device (1) and the portion to be protected of the part.

### FIELD OF THE INVENTION

The present invention relates to the field of surface treatments, and more particularly to the field of protecting and masking elements when applying a surface treatment.

### BACKGROUND OF THE INVENTION

When applying a surface treatment to a part, e.g. sandblasting, applying paint, or metal-plating, there are generally portions of the part that it is desirable to preserve from the treatment. These may be elements that are threaded or tapped, surfaces that have been machined such as piston rods, or indeed other portions of the part that have already received or that going to receive surface treatment that is different from the treatment that is being applied. Conventionally, such portions of the part are protected by masks constituted by sheets of card held in place by high performance adhesive tapes stuck onto the portion that is to be protected, or indeed flexible sheets of lead for operations such as sandblasting or metal-plating.

It often happens that the adhesive tape or its adhesion on the part becomes degraded because of surrounding conditions or under the effect of the treatment being applied to the part. Masks slide, thereby ceasing to protect the portion that is to be preserved and leading to non-compliances that can be expensive or impossible to correct, thereby leading to the entire part being rejected. Operations of putting such masks into place and of removing them are lengthy and have an impact on production times. The adhesive strip used is generally removed using sharp tools that might damage the part and/or injure operators and/or leave residues on the part. Finally, such masks constitute a large volume of waste that is usually not recyclable because of the nature of the substances covering them.

### OBJECT OF THE INVENTION

An object of the invention is to reduce the risks of damaging the part for treatment during such operations.

### SUMMARY OF THE INVENTION

To this end, the invention provides a protection device for protecting a portion to be protected of a part, the device comprising a separable body that can be separated into at least two sub-elements, each sub-element having a cavity for receiving at least partially the portion to be protected of the part. The device has holding means for holding the sub-elements in position relative to one another, and at least one of the sub-elements has a fraction of its cavity that is provided with a surface that opposes relative sliding between the protection device and the portion to be protected of the part.

Thus, the device for providing protection is easy to put into place and to remove because of its separable nature. Holding the protection device on the part with the help of a surface that opposes relative sliding between the device and the portion to be protected of the part eliminates any need to use sharp tools and the risks of damaging the part that might result therefrom.

Advantageously, the separable body of the device is cylindrical in shape and the holding means for holding the sub-elements in position relative to one another comprise at least one magnetic element.

Preferably, in this embodiment, at least one of the magnetic elements is a permanent magnet carried by one of the sub-elements of the separable body, and the permanent magnet is arranged so as to be capable of co-operating with another magnetic element that is carried by another of the sub-elements in order to hold these two sub-elements in position relative to each other.

In a particular embodiment, the surface opposing relative sliding of the device and the part to be protected comprises a material presenting a dry tack factor with steel that is greater than 0.6, this material preferably being rubber.

Preferably, the separable body is covered in silica on its outer periphery, thereby making it easier to clean in order to prolong reutilization thereof.

Also preferably, the separable body is a right circular cylindrical sleeve separable into first and second half-sleeves on a plane containing a longitudinal axis of the sleeve and defining junction surfaces of the first and second half-sleeves, and these junction surfaces are of mutually complementary shapes so as to limit the passage of material between the inside and the outside of the sleeve when the half-sleeves are joined together.

Preferably, in this last-mentioned embodiment, the junction surfaces of the first half-sleeve comprise at least one element exerting magnetic attraction on a corresponding element of the second half-sleeve.

Finally, the invention also provides a surface treatment method for treating a part, the method comprising the steps of:
placing a protection device in accordance with any embodiment of the invention around a portion of the part in such a manner as to protect said portion of the part by surrounding it with the protection device; and
performing a surface treatment operation on the part, the portion of the part that is surrounded with the protection device being preserved from the surface treatment by the protection device.

Typically, when a part is spared with the help of an adhesive tape, a certain amount of adhesive may remain on the part when the tape is cut away, the part might become scratched, and its quality may be degraded.

The advantage of the present method is:
firstly, in simple manner, to spare a surface of the part that is not to be reached by the surface treatment operation; and
secondly, once the surface treatment has been performed, to be able remove the protection device in simple manner without running the risk of damaging the part.

In a particular implementation of the method of the invention, a step of removing the protection device is performed after the step of performing the surface treatment operation on the part.

In a particular implementation of the method of the invention, the surface treatment operation is an operation that consists in making a coating on a surface of the part, which coating is defined at least in part at its periphery by the protection device.

In a particular implementation of the method of the invention, the coating is a paint or a deposit of metal.

In a particular implementation of the method of the invention, the protection device and the part are shaped in such a manner that when the protection device is put into place around the portion of the part, the part presents a fraction of its surface that is protected in waterproof manner by the protection device.

The term “waterproof” is used to mean that the surface that is protected in waterproof manner must be capable of being dipped together with the protection device once put into place in a depth of at least 1 meter of water at 20° C. without the surface that is protected in this way being wetted.

This waterproofing is achieved via a gasket placed all around the surfaces opposing sliding and/or by ensuring close contact between these surfaces that oppose sliding and the protected surface.

By way of example, this implementation makes it possible to dip the part:
into a bath of acid providing the material of the sliding surfaces is inert relative to acid; or
in a bath of paint; or
in an electrolytic metal-plating bath in order to apply treatment locally to a fraction of the surface of the part while sparing the protected surface that remains dry.

This waterproofing is enhanced by using holding means for holding sub-elements in position relative to one another where the holding means are preferably arranged to force said gaskets and/or said surfaces opposing sliding against the part.

This provides a protection device that adheres to the part:
firstly because the antislip surface is made of a material preferably presenting a dry tack factor on steel that is greater than 0.6; and
secondly because the position holding means force contact between the spared surface of the part and the surfaces of the protection device that oppose sliding relative to the part.

### BRIEF DESCRIPTION OF THE DRAWINGS

The invention can be better understood on reading the following description of non-limiting embodiments given with reference to the figures of the accompanying drawings, in which:

FIG. 1 is a diagrammatic perspective view of the protection device of the invention;

FIG. 2 is a cross-section view of the FIG. 1 device on a cross-section plane II-II;

FIG. 3 is a exploded diagrammatic perspective view of the FIG. 1 device;

FIGS. 4a, 4b, 4c, and 4d show successive steps performed for performing the method of the invention for treating a surface of a part; and

FIG. 5 is an exploded diagrammatic perspective view of a second embodiment of the device of the invention.

### DETAILED DESCRIPTION OF THE INVENTION

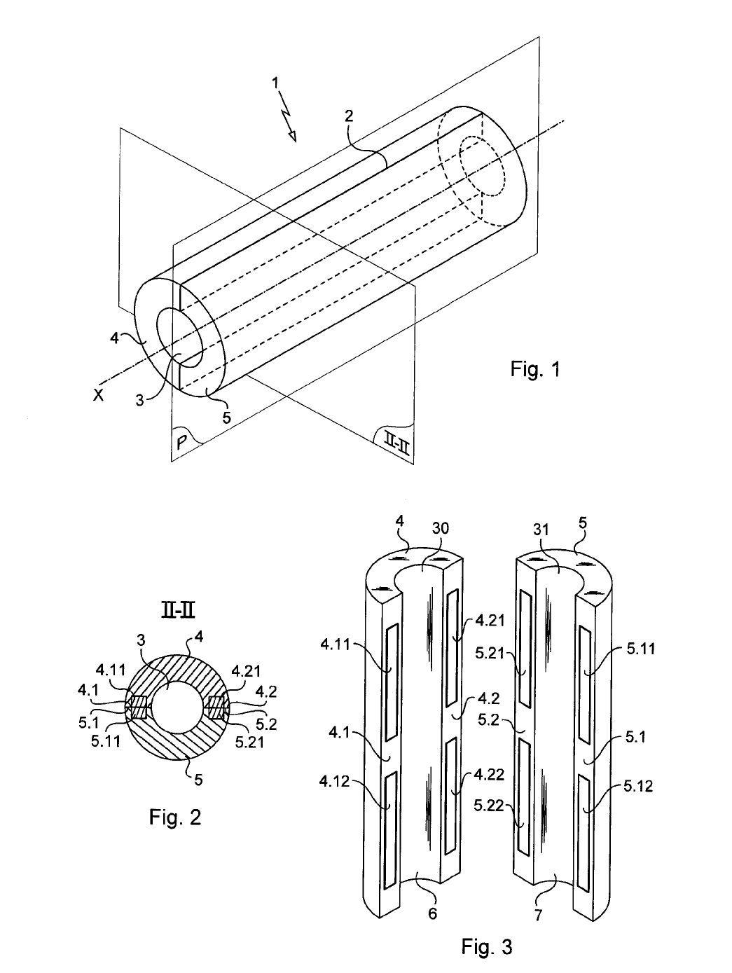

With reference to FIGS. 1 to 3, the protection device given overall reference 1 comprises a sleeve 2 in the form of a right circular cylinder made of rubber extending along a longitudinal axis X. It has an axial longitudinal cylindrical cavity 3 of right circular cylindrical shape and an outer coating of silica. The silica serves to limit the bonding of paint on the sleeve and thus serves to facilitate cleaning the sleeve.

The sleeve 2 is separable into two sub-elements in the form of a first half-sleeve 4 and a second half-sleeve 5, separation taking place along a plane P containing the longitudinal axis X. The plane P thus defines rectangular junction surfaces 4.1 and 4.2 of the first half-sleeve 4 that co-operate with corresponding junction surfaces 5.1 and 5.2 of the second half-sleeve 5. As can be seen in FIGS. 1 to 3, the junction surfaces 4.1 and 4.2 extend parallel to the longitudinal axis X on either side of a first fraction 6 of the cavity 3 corresponding to the imprint in each of the half-sleeves 4, 5 of the portion 23 of the part 20 that is to be protected. The half-sleeve 5 has a second cavity fraction 7 bordered by the junction surfaces 5.1 and 5.2. Each of the junction surfaces 4.1 and 4.2 has two rectangular block shape inserts respectively 4.11 & 4.12 and 4.21 & 4.22 extending parallel to the longitudinal axis X and made of magnetic material, in this example a neodymium alloy constituting a permanent magnet. The half-sleeve 5 has metal inserts 5.11, 5.12, 5.21, and 5.22 for co-operating with the inserts 4.11, 4.12, 4.21, and 4.22 of the half-sleeve 4. Preferably, some of the magnet-forming inserts and some of the metal inserts that are attached to the half-sleeves 4 and 5 are arranged at the longitudinal ends of the sleeve 2 so as to prevent the half-sleeves 4 and 5 splaying apart from each other at the longitudinal ends of the sleeve 2. It should be observed that these inserts forming magnets and/or some of the metal inserts may be covered in a thin film serving to limit any risk of the inserts being damaged (e.g. a risk of oxidation), and serving to limit any risk of the part for protection being damaged by making contact with these inserts.

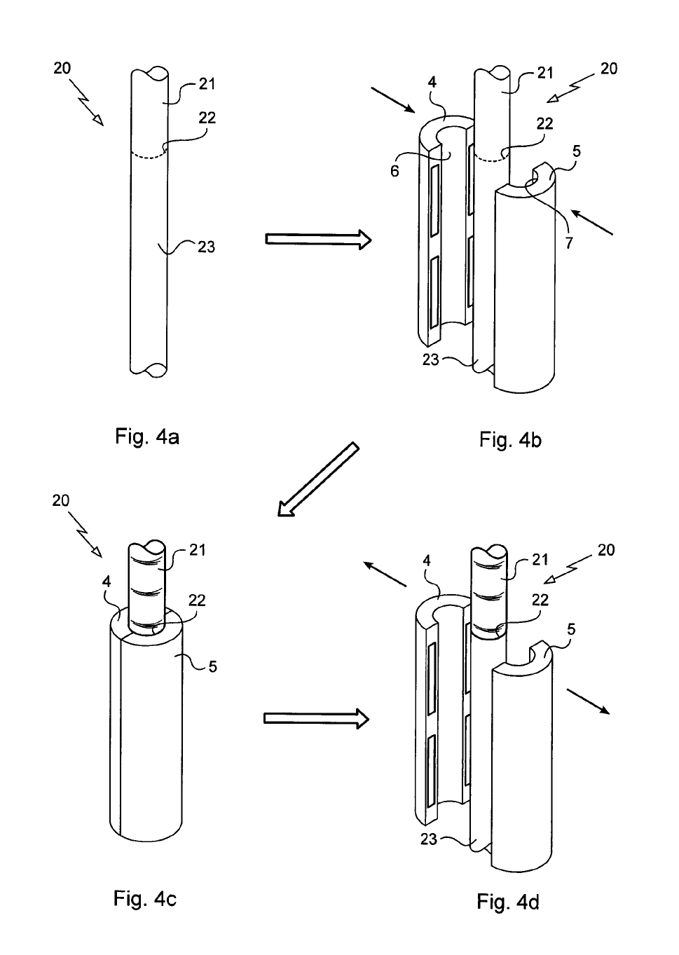

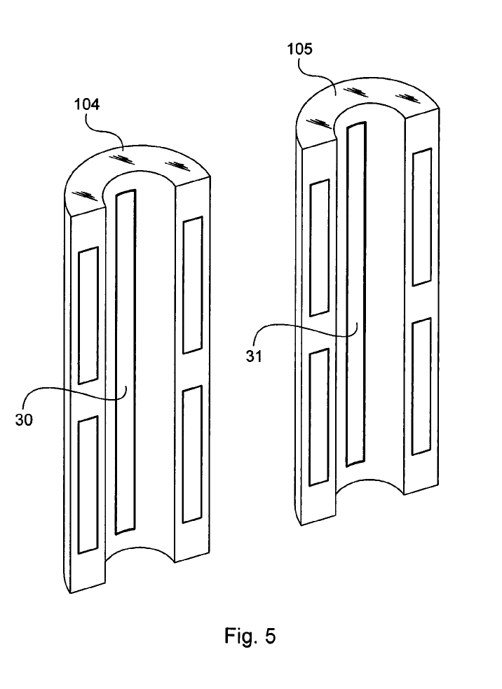

Use of the protection device 1 is described below with reference to FIGS. 4a, 4b, 4c, and 4d in application to applying surface treatments to a part for treatment, specifically a landing gear rod 20 for an aircraft. The landing gear rod 20 is made of metal and has a first portion 21 that is to receive surface treatment, in this example metal-plating, and that is separated by a boundary 22 from a second portion 23 that is to be protected since it is not to be metal-plated (FIG. 4a). The operator then puts the half-sleeves 4 and 5 into place on the second portion 23 so as to cause the first and second fractions 6 and 7 of the cavity 3 to co-operate with the portion 23 that is to be protected from metal-plating (FIG. 4c). In this situation, the protection device 1 covers the landing gear rod 20 in part, which rod has a portion that extends outside the protection device 1. The rectangular block inserts 4.11, 4.12, 4.21, and 4.22 then face the metal inserts 5.11, 5.12, 5.21, and 5.22 and magnetic attraction holds the half-sleeves 4 and 5 in contact together. This magnetic attraction also presses the surfaces 30 and 31 forming the cavity fractions 6 and 7 against the second portion 23 of the landing gear rod 20, thereby having the effect of any preventing any relative sliding of the half-sleeves 4 and 5 relative to the landing gear rod 20, given the particular coefficient of friction with the metal of the landing gear rod 20. In this example, the surfaces forming the cavity fractions are provided with a material presenting a dry tack factor on steel that is greater than 0.6. This material is the rubber forming the half-sleeves 4 and 5. In this configuration, one of the end of the sleeve 3 coincides with the boundary 22. Preferably, the sleeve is shaped so that when it is in position on the part, it then prevents fluid penetrating against the protected surface of the part 20. The metal-plating operation is performed by dipping the assembly comprising the sleeve and the part in a metal-plating bath, and the first portion 21 of the landing gear rod 20 then receives the metal-plating treatment. The portion 23 that is protected by the sleeve remains free from metal-plating. At the end of metal-plating, the two half-sleeves 4 and 5 are removed.

Elements that are identical or analogous to those described above are given references increased by 100 in the following description of the second embodiment.

With reference to FIG. 5, the cavity fractions 106 and 107 of the half-sleeves 104 and 105 have longitudinal inserts 30 and 31 made of tacky elastomer material such as rubber. Thus, when the half-sleeves are put into place on the portion 123 to be protected of the part, these inserts oppose relative sliding of the sleeves and the portion to be protected of the part.

Naturally, the invention is not limited to the embodiments described but covers any variant coming within the ambit of the invention as defined by the claims.

In particular:
although the separable body of the device as described is in the form of a right circular cylinder, the invention applies equally well to other shapes of separable bodies, such as for example a tubular body of square or arbitrary section or a body in the form of a rectangular block having a cavity;
although the body of the protection device as described is separable in the form of two half-sleeves, the invention is equally applicable to a body that is separable into three or more sub-elements;
although the body of the protection device as described has a longitudinal cylindrical cavity, the invention is equally applicable to other forms of cavity, such as cavities suitable for receiving singularities of the part, such as for example a flange, a shoulder, or a coupling;
although the junction surfaces of the half-sleeves as described have two rectangular inserts each, the invention is equally applicable to having a single insert or having more than two inserts. The invention is equally applicable to inserts of other shapes, such as for example inserts that are circular or of arbitrary shape;
although the first half-sleeve as described has inserts made of magnetic material for co-operating with metal inserts of the second half-sleeve, the invention is equally applicable to other means for holding the sleeves together in position, such as for example a self-gripping covering of the Velcro®, repositionable adhesive surfaces, or zip fasteners;
although the sleeve described is made of rubber, the invention is equally applicable to sleeves made of other materials, such as for example metal, wood, or synthetic material;
although the separable body described has two half-sleeves with cavities, each provided with a longitudinal insert made of tacky elastomer material, the invention is equally applicable to a body having a single sub-element provided with a longitudinal insert made of tacky elastomer material;
although the cavities described in the half-sleeves have longitudinal inserts made of tacky elastomer material, the invention is equally applicable to other types of portion of the cavity having a surface that opposes sliding, such as for example annular sections or a plurality of circular pads; and
although the sub-elements described of the separable body are presented as being disjoint from each other when they are separated, it is also possible for them to be connected together by a flexible connection allowing these sub-elements to be separated and spaced apart while maintaining a flexible attachment that imposes a maximum separation distance between these separable elements (thereby limiting any risk of losing one of the sub-elements while making the sub-elements easier to handle when they are separated).

1. A protection device (1) for protecting a portion (23) to be protected of a part, the device comprising a separable body (2) that can be separated into at least two sub-elements (4, 5), each sub-element (4, 5) having a cavity (6, 7) for receiving at least partially the portion (23) to be protected of the part, the device having holding means (4.11, 4.12, 4.21, 4.22, 5.11, 5.12, 5.21, 5.22) for holding the sub-elements (4, 5) in position relative to one another, and at least one of the sub-elements (4, 5) having a fraction of its cavity (6, 7) that is provided with a surface (30, 31) that opposes relative sliding between the protection device (1) and the portion (23) to be protected of the part.

2. A protection device (1) according to claim 1, wherein the separable body (2) is cylindrical in shape.

3. A protection device (1) according to claim 1, wherein the holding means (4.11, 4.12, 4.21, 4.22, 5.11, 5.12, 5.21, 5.22) for holding the sub-elements (4, 5) in position relative to one another comprise at least one magnetic element (4.11, 4.12, 4.21, 4.22).

4. A protection device (1) according to claim 3, wherein at least one of the magnetic elements is a permanent magnet carried by one of the sub-elements (4, 5) of the separable body, the permanent magnet being arranged so as to be capable of co-operating with another magnetic element that is carried by another of the sub-elements (4, 5) in order to hold these two sub-elements (4, 5) in position relative to each other.

5. A protection device (1) according to claim 1, wherein the surface (30, 31) opposing relative sliding of the device and the portion to be protected of the part comprise a material presenting a dry tack factor with steel that is greater than 0.6.

6. A protection device according to claim 5, wherein the surface opposing sliding is made of rubber.

7. A protection device (1) according to claim 1, wherein the separable body (2) is covered in silica on its outer periphery.

8. A protection device (1) according to claim 1, wherein the separable body (2) is a right circular cylindrical sleeve separable into first and second half-sleeves (4, 5) on a plane (P) containing a longitudinal axis (X) of the sleeve and defining junction surfaces (4.1, 4.2) of the first and second half-sleeves (4, 5), these junction surfaces being of mutually complementary shapes so as to limit the passage of material between the inside and the outside of the sleeve when the half-sleeves are joined together.

9. A protection device (1) according to claim 8, wherein the junction surface of the first half-sleeve (4) comprises at least one element (4.11, 4.12, 4.21, 4.22) exerting magnetic attraction on a corresponding element (5.11, 5.12, 5.21, 5.22) of the second half-sleeve (5).

10. A surface treatment method for treating the surface of a part (20), the method comprising the steps of:
placing a protection device (1) according to claim 1 around a portion (23) of the part (20) in such a manner as to protect said portion (23) of the part (20) by surrounding it with the protection device (1); and
performing a surface treatment operation on the part (20), the portion of the part that is surrounded with the protection device (1) being preserved from the surface treatment by the protection device (1).

11. A surface treatment method according to claim 10, including a step of removing the protection device (1) after the step of performing the surface treatment operation on the part.

12. A surface treatment method according to claim 10, wherein the surface treatment operation is an operation that consists in making a coating on a surface of the part, which coating is defined at least in part at its periphery by the protection device (1).

13. A surface treatment method according to claim 12, wherein the coating is a paint or a deposit of metal.

14. A surface treatment method according to claim 10, wherein the protection device (1) and the part (20) are shaped in such a manner that when the protection device (1) is put into place around the portion (23) of the part (20), the part presents a fraction of its surface that is protected in waterproof manner by the protection device (1).
